(19) United States
(12) Patent Application Publication
(10) Pub. No.: US 2009/0018850 A1
(43) Pub. Date: Jan. 15, 2009

(54) Security in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/827,401

(22) Filed: Jul. 10, 2007

(51) Int. Cl. G06Q 10/00

(52) U.S. Cl. 705/1

(57) ABSTRACT

A method and system of security in a geo-spatial environment are disclosed. In one embodiment, a method of organizing a community network includes obtaining member data associated with a member of the community network, determining a location of the member based on the member data, storing the member data in a member repository, obtaining a personal privacy preference from the member, applying the personal privacy preference to a geo-spatial map, and displaying the member data on the geo-spatial map based on the personal privacy preference. The method may further include determining a community membership of the member based on the location, obtaining a group privacy preference associated with the community membership from the member, determining a validation level of the member, applying the group privacy preference to the geo-spatial map based on the validation level, and displaying the location on the geo-spatial map based on the group privacy preference.

### FIELD OF TECHNOLOGY

This disclosure relates generally to the technical fields of communications and, in one example embodiment, to a method and system of security in a geo-spatial environment.

### BACKGROUND

A community network may correspond to a social structure made of nodes, which may include individuals and/or organizations, and links between the nodes. The links may correspond to varying degrees of social familiarity, from those of casual acquaintances to close familial bonds. Community networks may be tracked and maintained on web-based applications, enabling friends, business partners, and/or other individuals to connect with one another using a variety of tools. Additionally, the formation of the community networks on the web-based applications may allow parties to connect with one another regardless of geographic proximity.

In online community networks, users may create profiles that include information such as a name, address, contact information, picture, and/or other personal information. For example, a friend-based community network may allow users to upload photos to their profiles, while a business community network may allow users to include work experience, education, and/or references on their profiles. The online community networks may further allow the profiles to be edited by other users. For example, the users may be allowed to leave comments, testimonials, and/or recommendations on other users' profiles and/or associate the other users with uploaded pictures, videos, and/or other media.

Connections, or links, may be made between users in an online community network. For example, two users on the friend-based community network may become “friends” if both the users approve the connection. Similarly, a business connection may be made on a business community network if two users have worked together and/or are interested in collaborating on future work. Connections or links, between users form the basis of the online community networks and community network theory in general.

The online community networks may also provide mechanisms to ensure safety and privacy of users. For example, a user may specify privacy preferences associated with his/her profile. The privacy preferences may restrict access to one or more fields in the user's profile. For example, only users connected to the user may view the user's address, email address, phone number, etc. The privacy preferences may also restrict certain users from editing the user's profile. Because online security and privacy may play major roles in preventing serious incidents such as identity theft, online predation, and/or unwarranted release of private information, security and privacy mechanisms may need to be continually updated and improved.

### SUMMARY

A method and system of security in a geo-spatial environment are disclosed. In one aspect, a method of organizing a community network includes obtaining member data associated with a member of the community network, determining a location of the member based on the member data, storing the member data in a member repository, obtaining a personal privacy preference from the member, applying the personal privacy preference to a geo-spatial map, and displaying the member data at the location on the geo-spatial map based on the personal privacy preference.

The method may further include determining a community membership of the member based on the location, obtaining a group privacy preference associated with the community membership from the member, determining a validation level (e.g., based on a confirmation of the community membership of the member) of the member, applying the group privacy preference to the geo-spatial map based on the validation level, and displaying the location on the geo-spatial map based on the group privacy preference.

The method may further include restricting access to an address associated with the community membership based on the group privacy preference. The method may also include restricting access to a live webcam feed associated with the community membership based on the group privacy preference. The method may further include restricting access to an address of the member based on the personal privacy preference. In addition, the method may also include restricting access to a live webcam feed associated with the location based on the personal privacy preference.

In another aspect, a community network includes a member repository containing a number of members, a geo-spatial repository containing a number of locations on a geo-spatial map, a member management module configured to obtain member data (e.g., may include one of the locations) associated with one of the members, and a privacy module configured to obtain a personal privacy preference from the one of the members, apply the personal privacy preference to the geo-spatial map, and display the member data at the one of the locations on the geo-spatial map based on the personal privacy preference.

The privacy module may be further configured to determine a community membership of the one of the members based on the one of the locations, obtain a group privacy preference associated with the community membership from the one of the members, determine a validation level (e.g., based on a confirmation of the community membership of the one of the members) of the one of the members, apply the group privacy preference to the geo-spatial map based on the validation level, and display the one of the locations on the geo-spatial map based on the group privacy preference.

The privacy module may also be configured to restrict access to an address and a live webcam feed associated with the community membership based on the group privacy preference. The privacy module may also be configured to restrict access to an address of the one of the members and a live webcam feed associated with the one of the locations based on the personal privacy preference.

In yet another aspect, a method of configuring a community network for a member includes obtaining a location request from the member, displaying a location on a geo-spatial map corresponding to the location request, obtaining a selection for a camera view associated with the location from the member, displaying a live webcam feed associated with the camera view to the member, obtaining a first vote for a camera privacy preference from the member, and restricting access to the camera view based on the first vote.

The method may further include determining a validity (e.g., based on a residence of the member at the location) of the first vote, determining a validation level (e.g., based on a confirmation of the residence of the member at the location) of the member, applying the first vote to the camera privacy preference based on the validity and the validation level. The method may also include displaying an address associated with the location on the geo-spatial map, obtaining a second vote for an address privacy preference from the member, and restricting access to the address based on the second vote. The method may also include determining a validity of the second vote, determining a validation level of the member, and applying the second vote to the address privacy preference based on the validity and the validation level.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network enabling security in a geo-spatial environment, according to one embodiment.

FIG. 2 is a user interface view of obtaining a selection of a camera view associated with a physical location, according to one embodiment.

FIG. 3 is a user interface view of restricting access to an address and a webcam feed based on a personal privacy preference, according to one embodiment.

FIG. 4 is a user interface view of restricting access to the address and the webcam feed based on a group privacy preference, according to one embodiment.

FIG. 5 is a block diagram representation illustrating details associated with a member, according to one embodiment.

FIG. 6 is a flow chart of applying privacy preferences obtained from a member to a geo-spatial map, according to one embodiment.

FIG. 7 is a flow chart of restricting access to a camera view and/or an address based on a validity and a validation level, according to one embodiment.

FIG. 8 is a diagrammatic system view of a data processing system in which any of the embodiments disclosed herein may be performed, according to one embodiment.

FIG. 9A is a process flow of organizing the community network, according to one embodiment.

FIG. 9B is a continuation of the process flow of FIG. 9A illustrating additional processes, according to one embodiment.

FIG. 10A is a process flow of restricting access to a camera view and/or an address associated with a location based on a first vote and second vote respectively, according to one embodiment.

FIG. 10B is a continuation of process flow of FIG. 10A illustrating additional processes, according to one embodiment.

Other features of the present embodiments will be apparent from the accompanying drawings and from the detailed description that follows.

### DETAILED DESCRIPTION

A method and system of security in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

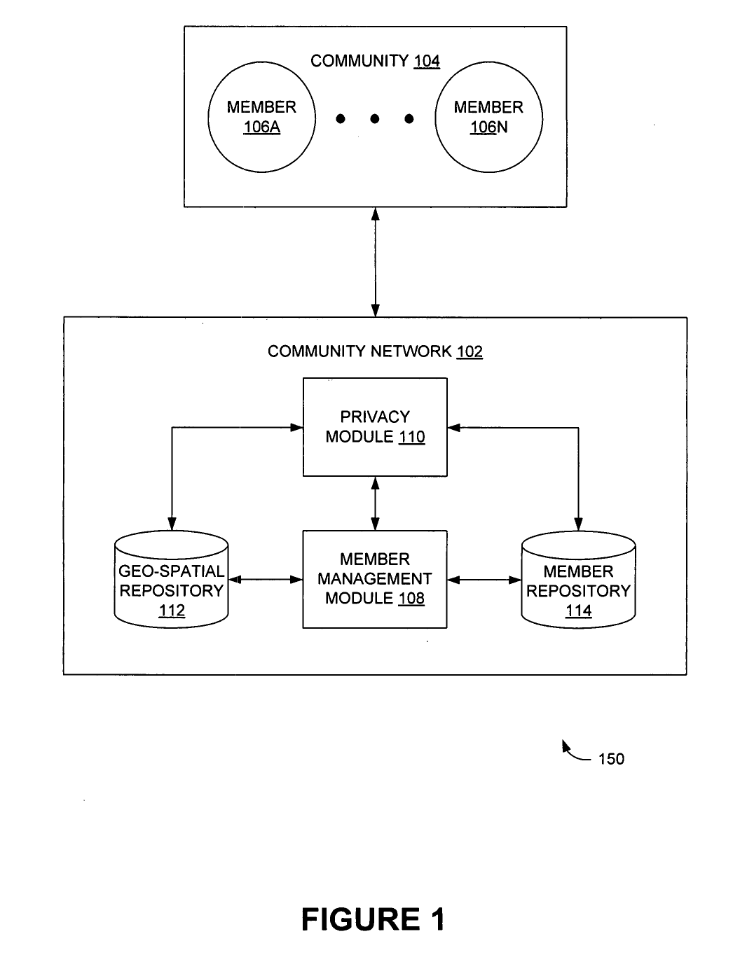

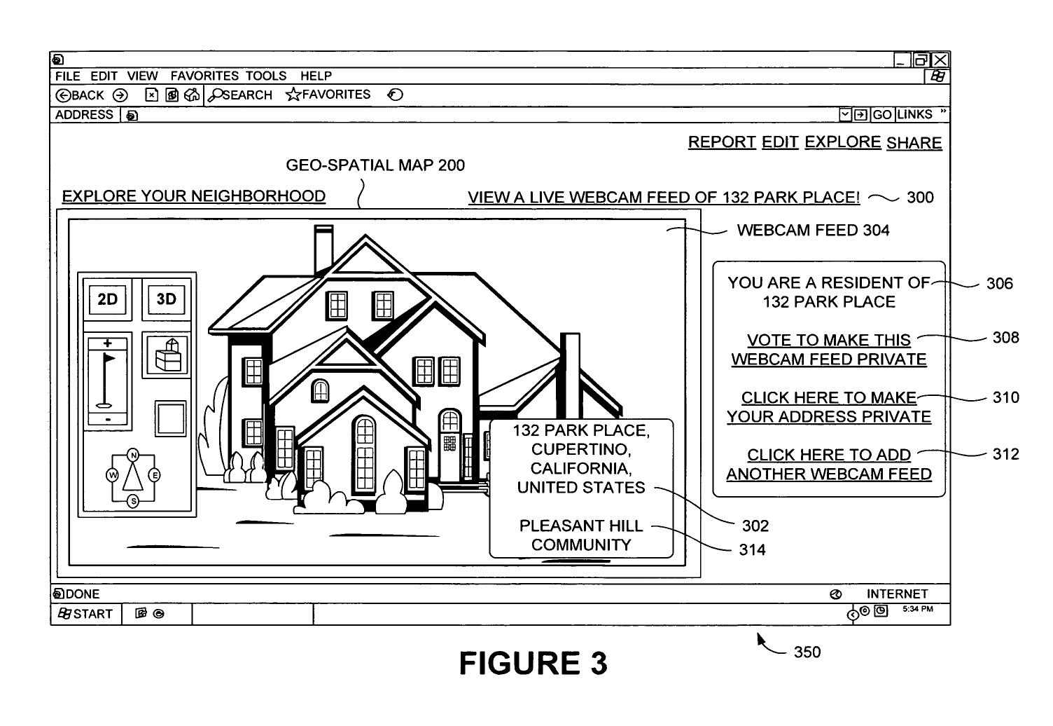

In one embodiment, a method of organizing a community network (e.g., the community network 102 of FIG. 1) includes obtaining member data (e.g., using the member management module 108 of FIG. 1) associated with a member (e.g., of the members 106A-N of FIG. 1) of the community network 102, determining a location of the member 106 based on the member data, storing the member data in a member repository (e.g., the member repository 114 of FIG. 1), obtaining a personal privacy preference (e.g., using the privacy module 110 of FIG. 1) from the member 106, applying the personal privacy preference to a geo-spatial map (e.g., the geo-spatial map 200 of FIG. 3), and displaying the member data at the location on the geo-spatial map 200 based on the personal privacy preference.

In another embodiment, a community network 102 includes a member repository (e.g., the member repository 114 of FIG. 1) including a number of members (e.g., the members 106A-N of FIG. 1), a geo-spatial repository (e.g., the geo-spatial repository 112 of FIG. 1) including a number of locations on a geo-spatial map 200, a member management module (e.g., the member management module 108 of FIG. 1) configured to obtain member data (e.g., may include one of the number of locations) associated with one of the members 106A-N, and a privacy module (e.g., the privacy module 110 of FIG. 1) configured to obtain a personal privacy preference from the one of the members 106A-N, apply the personal privacy preference to the geo-spatial map 200, and display the member data at the one of the locations on the geo-spatial map 200 based on the personal privacy preference.

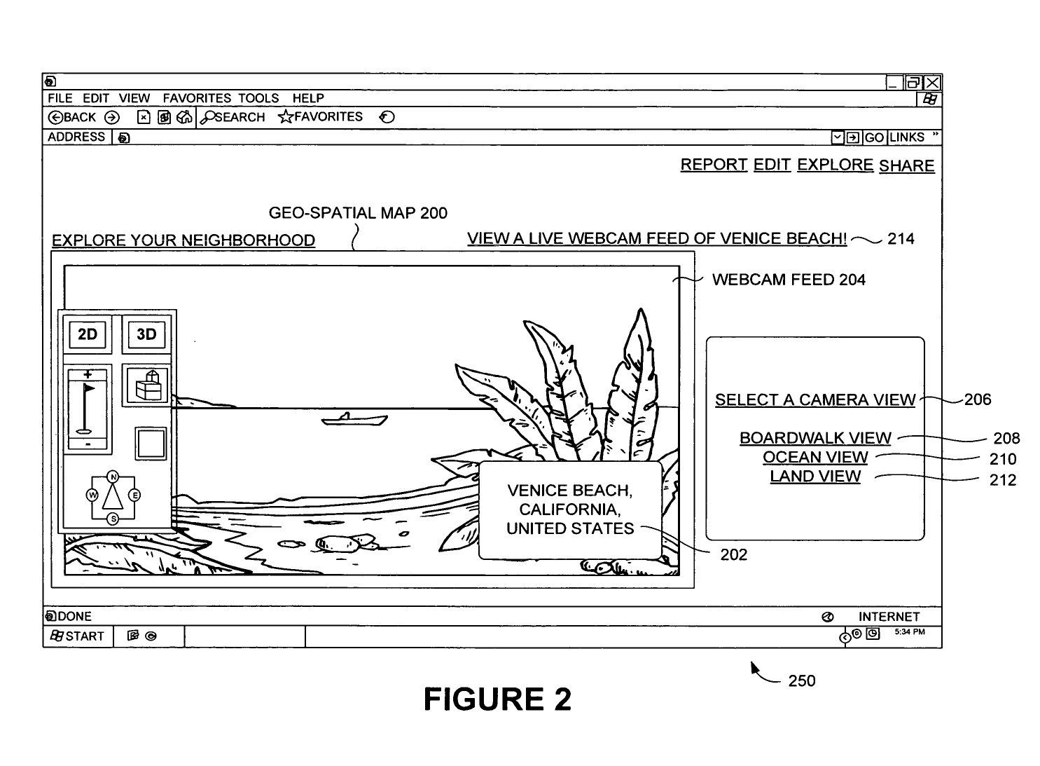

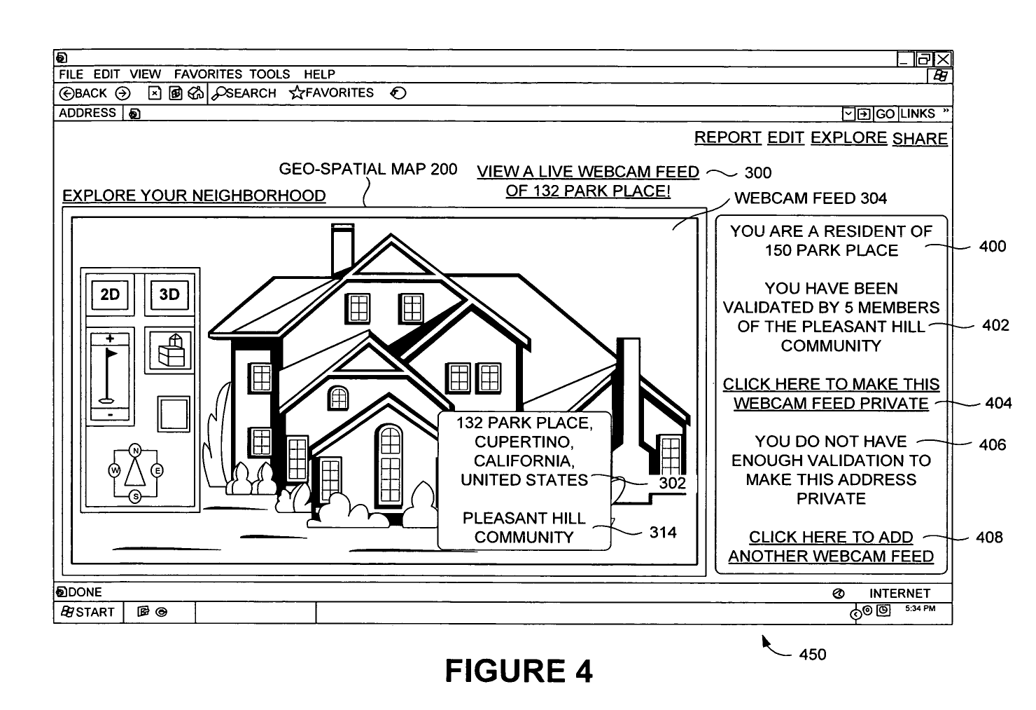

In yet another embodiment, a method of configuring a community network 102 for a member (e.g., the members 106A-N of FIG. 1) includes obtaining a location request from the member 106, displaying a location on a geo-spatial map 200 corresponding to the location request, obtaining a selection for a camera view (e.g., using the select a camera view option 206 of FIG. 2) associated with the location from the member 106, displaying a live webcam feed (e.g., the webcam feed 204 of FIG. 2 and the webcam feed 304 of FIG. 3-4) associated with the camera view to the member 106, obtaining a first vote (e.g., through the vote to make this webcam feed private option 308 of FIG. 3) for a camera privacy preference from the member 106, and restricting access to the camera view (e.g., using the click here to make this webcam feed private option 404 of FIG. 4) based on the first vote.

FIG. 1 is a system view 150 of a community network 102 enabling security in a geo-spatial environment, according to one embodiment. Particularly, FIG. 1 illustrates the community network 102, a community 104, members 106A-N, a member management module 108, a privacy module 110, a geo-spatial repository 112 and a member repository 114, according to one embodiment.

The community network 102 may be a network formed by an association of the members 106A-N having profiles associated with physical locations in the community 104. For example, the community network 102 may enable installation of security devices (e.g., cameras, alarms, etc.) at a physical location (e.g., residence, business, organization, street, public place, etc.) in a neighborhood. As a result, the members 106A-N may view a live webcam feed (e.g., the webcam feed 304 of FIGS. 3-4) of the physical location associated with a camera view. In one example embodiment, one or more security devices may be installed at the physical location to enable viewing of the live webcam feed of the physical location in different perspectives (e.g., bird's eye view, satellite view, street view, etc.). In addition, the community network 102 may enable the members 106A-N to create profiles containing information such as a name, address, contact information, picture and/or groups, etc. associated with other members 106A-N of the community 104 and/or neighbors in the neighborhood.

The community 104 may refer to a group of members 106A-N residing in a neighborhood and connected with each other through the community network 102. For example, the neighborhood may correspond to a street, city, county, and/or country, etc. The members 106A-N may include individuals and/or group of members associated with physical locations (e.g., residence, businesses, and/or organizations) and having user profiles in the community network 102. Alternatively, the members 106A-N may also reside in multiple regions (e.g., multiple cities, states, countries, etc.). The members 106A-N may be connected through the community network 102, which may be accessible through a network (e.g., the internet).

The member management module 108 may obtain member data associated with the members 106A-N of the community network 102. For example, the member data may include name, location information, phone number, and/or communities associated with the members 106A-N. The member data may be displayed in user profiles of the members 106A-N on a geo-spatial map (e.g., the geo-spatial map 200 of FIGS. 2, 3 and 4). In one example embodiment, the user profiles containing the member data (e.g., address data, community, etc.) may be displayed on a webcam feed (e.g., the webcam feed 204 of FIG. 2) associated with a physical location. In addition, profiles of the members 106A-N of the community 104 may be editable by other members based on group privacy preferences and/or personal privacy preferences (e.g., selected by a member 106).

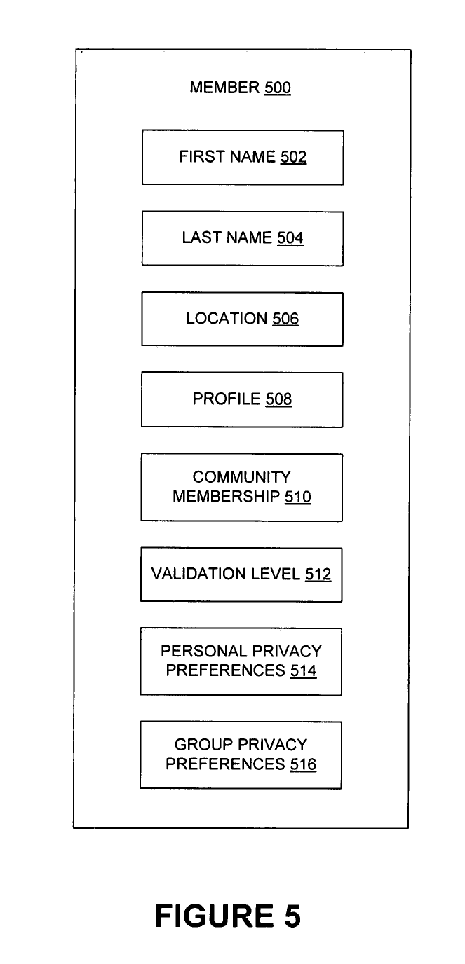

The privacy module 10 may enable selection of the personal privacy preferences and/or the group privacy preferences. In one example embodiment, the personal privacy preferences may include restricting access to the members 106A-N of the community network 102 from editing a member's profile (e.g., the profile 508 of FIG. 5) and/or viewing a webcam feed (e.g., the webcam feed 304 of FIG. 3) of a physical location associated with a member 106. In addition, the personal privacy preference may be selected by the member 106 associated with the physical location. For example, members 106A-N connected to the member 106 may be allowed to view the member's profile which includes address, email address, phone number, and/or live webcam feed 204, etc.

In another example embodiment, the group privacy preference may include restricting the members 106A-N of the community network 102 from accessing profiles (e.g., address, contact number, and/or personal information such as name, profession, etc.) and/or webcam feeds associated with physical locations of neighbors and/or other members 106A-N of the community 104 (e.g., based on the group privacy preference specified by the member 106). For example, the member 106 may specify the group privacy preferences to restrict access to one or more fields in a neighbor's profile associated with the community membership based on a confirmation of the community membership of the member 106.

In one or more embodiments, the member 106 may select group privacy preferences for other members 106A-N of the community 104 based on a validation level of the member 106 in the community 104. The validation level may be determined based on a confirmation of the physical location of the member 106 by the other members 106A-N of the community 104. For example, if the member 106 has a high validation level, then the member 106 may be allowed to specify the group privacy preferences.

For example, the member 106 may also select preferences such that other members 106A-N may view publicly available information (e.g., such as name, address, etc.) and restrict access to personal information (e.g., such as phone number, hobbies, etc.) associated with the member 106 as well as other members 106A-N of the community 104.

The geo-spatial repository 112 may be a database containing location information associated with the members 106A-N of the community 104 on the geo-spatial map 200. The member repository 114 may be a database containing the member data associated with the members 106A-N. In one example embodiment, a webcam feed 204 associated with a physical location of the member 106 may be obtained on the geo-spatial map 200 using information stored in the member repository 114 and the geo-spatial repository 112.

In the example embodiment illustrated in FIG. 1, the community network 102 includes the member management module 108, the privacy module 110, the geo-spatial repository 112, and the member repository 114, interacting with each other.

In accordance with one or more embodiments, a location request may be obtained from a member 106 and a location may be displayed on a geo-spatial map 200 corresponding to the location request. A selection for a camera view associated with the location may be obtained (e.g., using the select a camera view option 206 of FIG. 2) from the member 106. A live webcam feed (e.g., the webcam feed 204 of FIG. 2) associated with the camera view (e.g., boardwalk view 208, ocean view 210 and/or land view 212 of FIG. 2) may be displayed to the member 106 on the geo-spatial map 200.

A first vote for a camera privacy preference may be obtained (e.g., using the vote to make this webcam feed private option 308 of FIG. 3) from the member 106. Further, access to the camera view may be restricted (e.g., using the privacy module 110 of FIG. 1) based on the first vote. A validity of the first vote may be determined (e.g., based on a residence of the member 106 at the location). A validation level of the member 106 may be determined (e.g., based on a confirmation of the residence associated with the member 106 at the location). The first vote may be applied to the camera privacy preference based on the validity and/or the validation level.

An address (e.g., the address 302 of FIG. 3-4) associated with the location may be displayed on the geo-spatial map 200. A second vote for an address privacy preference may be obtained (e.g., using the click here to make your address private option 310 of FIG. 3) from the member 106 and access to the address 302 may be restricted based on the second vote. A validity of the second vote may be determined. A validation level of the member 106 may be determined. The second vote may be applied to the address privacy preference based on the validity and/or the validation level.

For example, the member management module 108 may be configured to obtain member data (e.g., may include one of the locations) associated with a member 106. The privacy module 110 may be configured to obtain a personal privacy preference from the member 106, apply the personal privacy preference to the geo-spatial map 200 and display the member data at the location on the geo-spatial map 200 based on the personal privacy preference.

The privacy module 110 may further be configured to determine a community membership of the member 106 based on the one of the locations, obtain a group privacy preference associated with the community membership from the member 106, determine a validation level of the member 106 (e.g., based on a confirmation of the community membership of the member 106 at the location), apply the group privacy preference to the geo-spatial map 200 based on the validation level and/or display the location on the geo-spatial map 200 based on the group privacy preference.

In one embodiment, the privacy module 110 may be configured to restrict access to an address associated with the community membership and a live webcam feed (e.g., the webcam feed 304 of FIG. 4) associated with the community membership (e.g., based on the group privacy preference). In another embodiment, the privacy module 110 may be configured to restrict access to an address of the member 106 (e.g., based on the personal privacy preference) and a live webcam feed (e.g., the webcam feed 304 of FIG. 3) associated with the location (e.g., based on the personal privacy preference).

FIG. 2 is a user interface view 250 of obtaining a selection of a camera view associated with a physical location, according to one embodiment. Particularly, FIG. 2 illustrates a geo-spatial map 200, an address block 202, a webcam feed 204, a select a camera view option 206, a boardwalk view 208, an ocean view 210, a land view 212 and a view a live webcam feed option 214, according to one embodiment.

The geo-spatial map 200 may graphically visualize the webcam feed 204 of a physical location associated with a camera view. The address block 202 may display an address data (e.g., name, street, city, country, zip code, etc.) associated with the physical location on the webcam feed 204. The webcam feed 204 may show a live webcam view (e.g., corresponding to a camera view) of a physical location (e.g., residence, public places, oceans, etc.) associated with an address data on the geo-spatial map 200. The live webcam view may be obtained by installing cameras at a particular location and/or particular region.

The select a camera view option 206 may enable selection of different types of camera views (e.g., the boardwalk view 208, the ocean view 210, and/or the land view 212, etc.), each camera view associated with a visual perception of the physical location and/or region. The boardwalk view 208 may be a camera view of a wooden path for pedestrians and/or vehicles, located proximate to beachfront communities. The ocean view 210 may be a visual representation of an ocean. The land view 212 may correspond to a camera view of the physical location such as residences, restaurants, parks, and/or public places. In one example embodiment, the members 106A-N may select a desired camera view (e.g., the boardwalk view 208, the ocean view 210 and/or the land view 212) associated with the physical location using the select a camera view option 206.

In addition, the desired camera view may be obtained by installing cameras in the physical location corresponding to a particular view (e.g., the boardwalk view 208, the ocean view 210 and/or the land view 212). The view a live webcam feed option 214 may enable selection of the live webcam feed 204 associated with the physical location. As mentioned above, the live webcam feed 204 may correspond to the camera view associated with a residence, public place, and/or organization, etc.

In the example embodiment illustrated in FIG. 2, the user interface view 250 displays the live webcam feed 204 of an ocean (e.g., Venice Beach) and the address block 202. The address block 202 displays an address “Venice Beach, Calif., United States” associated with Venice Beach. The members 106A-N may select the webcam feed 204 associated with Venice Beach using the view a live webcam feed option 214. In addition, the members 106A-N may also specify a type of a camera view (e.g., the boardwalk view 208, the ocean view 210, and/or the land view 212) associated with the webcam feed 204 of Venice Beach. Further, the members 106A-N may view a live webcam feed 204 associated with the selected camera view on the geo-spatial map 200.

The user interface view 250 also displays a toolbar through which the members 106A-N may access the live webcam feed 204 and/or the address 202 associated with Venice Beach. For example, the 2D option may allow the members 106A-N to visualize two-dimensional view of Venice Beach on the geo-spatial map 200. The 3D option may enable the members 106A-N of the community 104 to generate the three-dimensional view of Venice Beach on the geo-spatial map 200. The zoom control may facilitate the members 106A-N to zoom in or zoom out the Venice Beach view on the geo-spatial map to a desired scale. The geographical direction indicator option may facilitate the members 106A-N to view other sides of the webcam feed 204 based on a latitude and longitude associated with Venice Beach.

FIG. 3 is a user interface view 350 of restricting access to an address 302 and a webcam feed 304 based on a personal privacy preference, according to one embodiment. Particularly, FIG. 3 illustrates the geo-spatial map 200, a view a live webcam feed option 300, an address 302, a webcam feed 304, an option 306, a vote option 308, a click here to make your address private option 310, a click here to add another webcam feed option 312 and a pleasant hill community 314, according to one embodiment.

The view a live webcam feed option 300 may enable the members 106A-N to view the webcam feed 304 of a physical location associated with the address 302. The webcam feed 304 may show a live webcam view (e.g., corresponding to a camera view) of a physical location (e.g., residence) associated with an address data of the member 106 on the geo-spatial map 200. The live webcam view may be obtained by installing cameras at a particular location and/or particular region.

The address 302 may represent location information (e.g., address data) associated with the webcam feed 304 of the physical location. The option 306 may display information regarding a confirmation of the physical location (e.g., validation level) of the member 106 associated with the physical location. For example, the member 106 may specify a personal privacy preference (e.g., address privacy and/or camera privacy) corresponding to the webcam feed 304 of the physical location based on the physical location of the member 106 in the community 104 (e.g., Pleasant Hill Community 314).

The vote option 308 may enable the member 106 to specify the personal privacy preference associated with the webcam feed 304. For example, the member 106 may specify the personal privacy preference to make the webcam feed 304 private using the vote option 308. The click here to make your address private option 310 may enable the member 106 to restrict access to the address 302 associated with the physical location. In one example embodiment, the member 106 may specify a personal privacy preference to make the address 302 private through the click here to make your address private option 310.

The click here to add another webcam feed option 312 may enable the member 106 to select different camera view (e.g., webcam feed) associated with the physical location. For example, the member 106 may select another camera view of the physical location to view another webcam feed and/or restrict the access to another webcam feed. The Pleasant Hill Community 314 may be a group or community (e.g., neighborhood, particular area and/or region, etc.) in which the member 106 is associated with a community membership.

In the example embodiment illustrated in FIG. 3, the user interface view 350 displays the live webcam feed 304 of a residence of the member 106 and the address “132 park place, Cupertino, Calif., United States” associated with the residence on the geo-spatial map 200. The member 106 may have a community membership in a Pleasant Hill Community 314. The option 306 displays “You are a resident of 132 park place” representing the member 106 is a resident of the physical location associated with the webcam feed 304 and/or address 302. Further, the camera privacy preference may be selected by the member 106 to restrict the access to the webcam feed 304 associated with the physical location by using the vote to make this webcam feed private option 308. The address privacy preference may be specified by the member 106 to restrict access to the address 302 associated with the physical location using the click here to make your address private option 312.

In one example embodiment, the member 106 may restrict access to personal information (e.g., phone number, email id, etc.) associated with his/her profile data and/or provide access to publicly available information (e.g., address 302) associated with the webcam feed 304. Alternatively, the member 106 may provide access to the members 106A-N associated with the Pleasant Hill Community 314. For example, members 106A-N connected to the member 106 may view the member's profile (e.g., address, community membership, and/or other personal information) and/or webcam feed 304 associated with the member's location. The member 106 may also upload/create new webcam feeds of the physical location (e.g., residence, business and/or organization) associated with the address 302 using the click here to add another webcam feed 312.

In accordance with one or more embodiments, member data associated with a member (e.g., the members 106A-N of FIG. 1) of the community network 102 may be obtained (e.g., using the member management module 108 of FIG. 1) and a location of the member 106 may be determined based on the member data. The member data may be stored in the member repository 114. A personal privacy preference may be obtained (e.g., using the privacy module 110 of FIG. 1) from the member 106 and applied to a geo-spatial map (e.g., the geo-spatial map 200 of FIG. 3). The member 106 data may be displayed at the location on the geo-spatial map 200 based on the personal privacy preference. In addition, access to an address (e.g., the address 302 of FIG. 3) of the member 106 and/or to a live webcam feed associated with the location may be restricted (e.g., based on the personal privacy preference).

FIG. 4 is a user interface view 450 of restricting access to the address 302 and the webcam feed 304 based on a group privacy preference, according to one embodiment. Particularly, FIG. 4 illustrates the geo-spatial map 200, the view a live webcam feed option 300, the address 302, the pleasant hill community 314, a confirmation block 400, a validation block 402, a click here to make this webcam private option 404, a block 406 and a click here to add another webcam feed option 408, according to one embodiment.

The confirmation block 400 may display information (e.g., validity) regarding a physical location associated with a neighbor of the member 106 in the community 104 (e.g., Pleasant Hill Community 314). The validation block 402 may display information representing a validation level of the neighbor in the community 104 (e.g., Pleasant Hill Community 314). In one example embodiment, other members 106A-N of the group (e.g., Pleasant Hill Community 314) may respond to the neighbor's request for making the webcam feed 304 and/or address 302 associated with the physical location private (e.g., through confirming the neighbor's location in the community 104).

The click here to make this webcam feed private option 404 may enable the neighbor (e.g., may be another member 106 of the Pleasant Hill Community 314) to restrict access to the webcam feed 304 associated with the member's physical location (e.g., associated with the address 302) based on the validation level (e.g., as illustrated in the validation block 402). The block 406 may display information associated with the validation level of the member 106 to make the address 302 private. For example, the block may give information of the neighbor indicating whether the neighbor has enough validation level or not to restrict access to the address 302 associated with the webcam feed 304. The click here to add another webcam feed option 312 may allow the neighbor to select another camera view (e.g., webcam feed) associated with the physical location.

In the example embodiment illustrated in FIG. 4, the user interface view 450 displays the webcam feed 304 associated with the address 302. The confirmation block 400 displays “You are a resident of 150 Park Place” indicating the confirmation of the residence of the neighbor in a vicinity of the address 302 (e.g., associated with the Pleasant Hill Community 314). In one example embodiment, the member 106 is associated with the address “132 Park Place, Cupertino, Calif., United States” and the neighbor is associated with an address “150 park place, Cupertino, Calif., United States” thereby representing the fact that both the member 106 and the neighbor are associated with Pleasant Hill Community 314. The validation block 402 displays “You have been validated by 5 members 106A-N of the Pleasant Hill Community”, thereby indicating the validation level of the neighbor to render the webcam feed 304 private. Since the neighbor has been validated by 5 members of the Pleasant Hill Community 314, the neighbor may restrict other members 106A-N of the community network 102 to access the webcam feed 304 (e.g., based on the group privacy preference) associated with the member's physical location using the click here to make this webcam feed private option 404.

However, the neighbor may not be allowed to restrict the access to the address 302 since the neighbor does not have enough validation level to make the address private. For example, the block 406 displays “You do not have enough validation to make this address private” indicating that the neighbor is not allowed to restrict access to the address 302 (e.g., of the member 106 of FIG. 1) associated with the webcam feed 304.

In one example embodiment, the access to the webcam feed 304 (e.g., camera view) may be restricted based on a validity and/or a validation level. The validity may be determined based on the residence of the neighbor at the location in the Pleasant Hill Community 314. The validation level may be determined based on a confirmation of the residence of the neighbor at the address (e.g., as illustrated in confirmation block 400). For example, the confirmation of the residence of the neighbor at the address may be validated by the other members 106A-N of the Pleasant Hill Community 314.

In accordance with one or more embodiments, a community membership of a member 106 (e.g., neighbor) may be determined based on the location. A group privacy preference associated with the community membership may be obtained (e.g., using the privacy module 110 of FIG. 1) from the member 106. A validation level of the member 106 may be determined (e.g., based on a confirmation of the community membership of the member 106). The group privacy preference may be applied to the geo-spatial map 200 based on the validation level. The location may be displayed on the geo-spatial map 200 based on the group privacy preference. In addition, access to the address 302 associated with the community membership and/or the live webcam feed 304 associated with the community membership may be restricted (e.g., based on the group privacy preference).

FIG. 5 is a block diagram representation illustrating details associated with a member 500 (e.g., the members 106A-N illustrated in FIG. 1), according to one embodiment. Particularly, FIG. 5 illustrates the member 500, a first name block 502, a last name block 504, a location block 506, a profile block 508, a community membership block 510, a validation level block 512, a personal privacy preferences block 514 and a group privacy preferences block 516, according to one embodiment.

The member 500 may correspond to an individual having a user profile in the community network 102. The first name block 502 may display first name associated with the member 500. The last name block 504 may display last name associated with the member 500. The location block 506 may display an address data associated with the member 500. The profile block 508 may display profile details associated with the member 500. For example, the profile details may include personal information such as age, gender, profession, hobbies, address, camera view associated with the location and/or group information such as membership in a community.

The community membership block 510 may display a name of a community 104 or group in which the member 500 has a membership. For example, the community membership block 510 may display “Pleasant Hill Community” if the member 500 has a membership in that community. The validation level block 512 may display information regarding a validation level of the member 500. In one example embodiment, the validation level may be determined based on a confirmation of the physical location by the other members 106A-N of the community 104. The personal privacy preferences block 514 may display information regarding privacy preferences selected by the member 500 to restrict access to the address (e.g., address 302 of FIG. 3) and/or the webcam feed (e.g., the webcam feed 304 of FIG. 3) associated with the physical location. The group privacy preferences block 516 may display information regarding privacy preferences selected by the member 500 to restrict access to the address (e.g., the address 302 of FIG. 4) and/or the webcam feed (e.g., the webcam feed 304 of FIG. 4) associated with other members of the community 104.

In the example embodiment illustrated in FIG. 5, the block diagram representation shows various details (e.g., address data, content data, etc. stored in the member repository 114) associated with the member 500. Other members 106A-N may access an address data and/or a webcam feed of a physical location associated with the address data based on the group privacy preferences and/or personal privacy preferences specified by the member 500. Other members 106A-N may search for the member 500 based on the first name, the last name, the location, the profile, the community membership associated with the member 500.

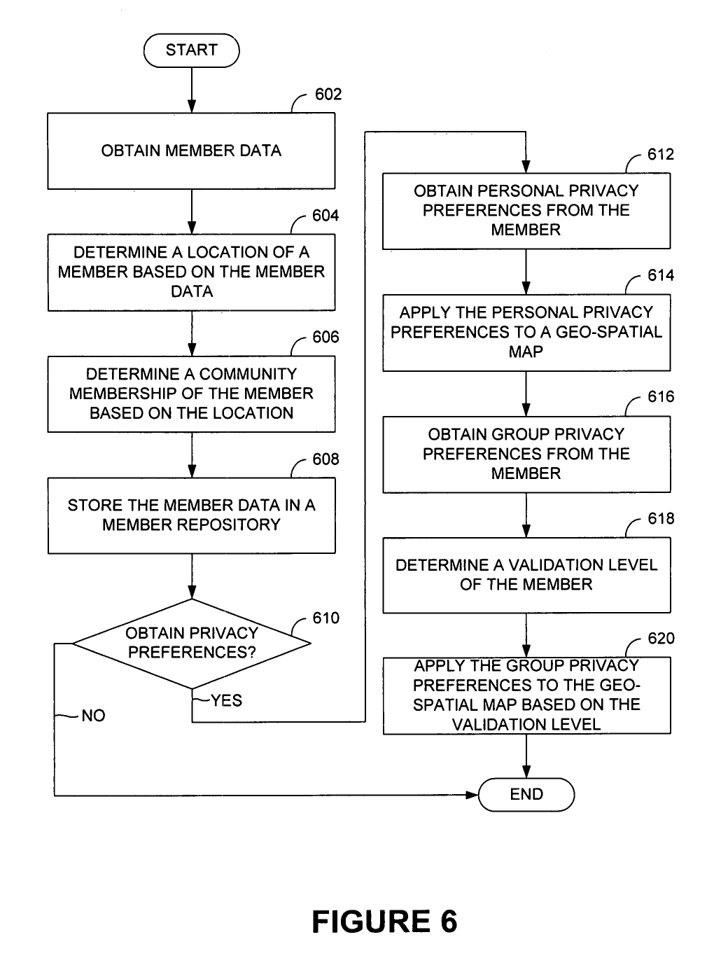

FIG. 6 is a flow chart of applying privacy preferences obtained from a member (e.g., the members 106A-N of FIG. 1) to a geo-spatial map (e.g., the geo-spatial map 200 of FIGS. 2, 3, and 4), according to one embodiment. In operation 602, member data is obtained (e.g., using the member management module 108 of FIG. 1) from the member 106. For example, the member data may include an age, gender, profession, hobbies, address, etc. In operation 604, a location of the member 106 is determined (e.g., using the geo-spatial repository 112 of FIG. 1) based on the member data. For example, the location may include residence, business, organization, civic structure, street, and/or public places, etc. In operation 606, a community membership of the member 106 is determined based on the location. For example, the community membership is determined based on the connectedness of the member 106 associated with the location (e.g., residence, business, organization, etc.) in a community (e.g., the community 104 of FIG. 1).

In operation 608, the member data is stored in a member repository (e.g., the member repository 114 of FIG. 1). For example, the member repository 114 may include personal information (e.g., telephone number, email id, profession, etc.) as well as publicly available information (e.g., address data) associated with members 106A-N. In operation 610, a determination is made whether the privacy preferences are obtained from the member 106. For example, the privacy preferences may include personal privacy preferences and/or group privacy preferences. If the member 106 is not willing to specify privacy preferences then the process may terminate.

If the member 106 is willing to specify privacy preferences then personal privacy preferences are obtained from the member 106 in operation 612. For example, the personal privacy preferences may restrict certain members 106A-N of the community network 102 to access one or more fields in member's profile. For example, the member's profile may include an address (e.g., the address 302 of FIG. 3) and/or a live webcam view (e.g., the live webcam feed 304 of FIG. 3) of a physical location of the member 106 associated with the address 302. In operation 614, the personal privacy preferences (e.g., obtained from the member 106) are applied to the geo-spatial map 200. For example, member data accessible to the other members 106A-N of the community 104 may be displayed on the geo-spatial map based on the personal privacy preferences selected by the member 106.

In operation 616, group privacy preferences are obtained from the member 106. For example, the group privacy preferences may restrict certain members (e.g., the members 106A-N of FIG. 1) of a community network 102 (e.g., the Pleasant Hill Community 314 of FIG. 4) to access one or more fields of other member's profiles in the community 104. In one example embodiment, the group privacy preferences may be preferences specified by the member 106 corresponding to other members 106A-N profile and/or neighbors profile in the community 104. In operation 618, a validation level of the member 106 is determined (e.g., based on a confirmation of the community membership of the member 106) by the other members 106A-N of the group (e.g., the Pleasant Hill Community 314 of FIG. 4). In operation 620, the group privacy preferences are applied to the geo-spatial map 200 based on the validation level. For example, the member data accessible to the other members 106A-N of the community 104 (e.g., the Pleasant Hill Community 314 of FIG. 4) may be displayed on the geo-spatial map 200 based on the group privacy preferences selected by the member 106.

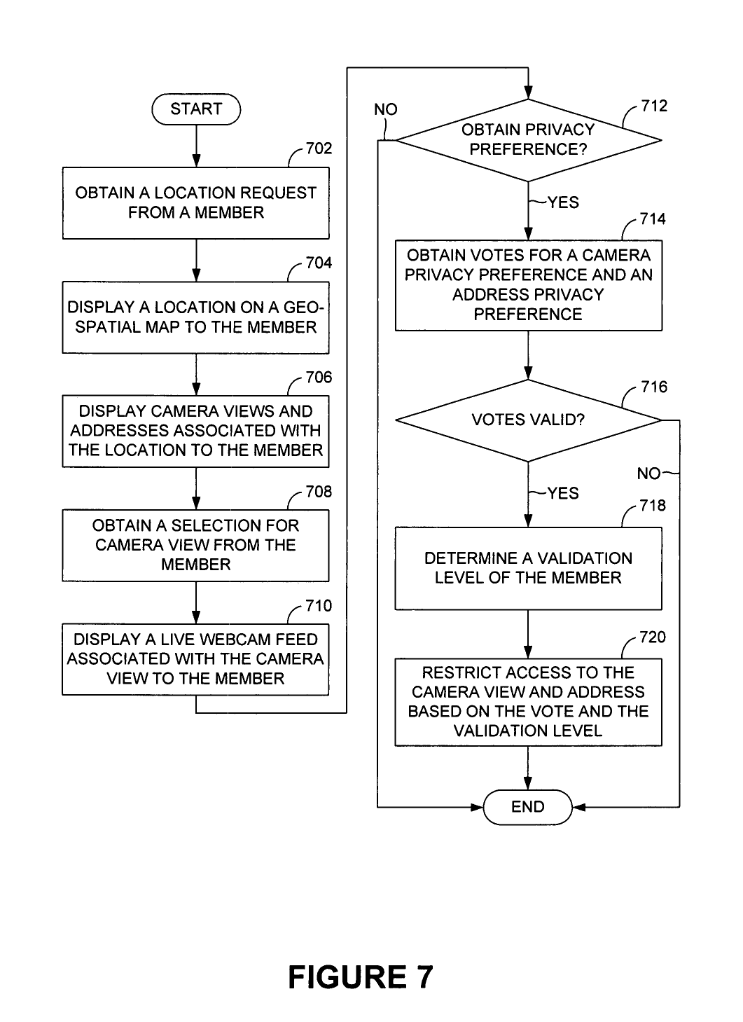

FIG. 7 is a flow chart of restricting access to a camera view and/or an address based on a validity and a validation level, according to one embodiment. In operation 702, a location request is obtained from a member 106. In operation 704, the location is displayed on a geo-spatial map 200 to the member 106. In operation 706, camera views (e.g., the boardwalk view 208, ocean view 210, and/or land view 212 of FIG. 2) and/or addresses (e.g., the address 202 of FIG. 2) associated with the location are displayed to the member 106. For example, the camera views may be displayed by installing physical cameras at a location corresponding to an address. The addresses may be displayed in the member's profile (e.g., visualized on the webcam feed 204 of FIG. 2) associated with the member 106.

In operation 708, a selection for a camera view is obtained from the member 106. For example, the member 106 may select a camera view from a number of camera views (e.g., boardwalk view 208, ocean view 210, and/or land view 212, etc. of FIG. 2) associated with the location. In operation 710, a live webcam feed (e.g., the webcam feed 204 of FIG. 2) associated with the camera view is displayed to the member 106. For example, the live webcam feed 304 may display the photographic image of the camera view associated with the location.

In operation 712, a determination is made on whether a privacy preference is obtained from the member 106 or not. If the member 106 is not willing to specify the privacy preference then the process may terminate. If the privacy preference is obtained from the member 106, then votes are obtained for a camera privacy preference and/or address privacy preference from the member 106. In one embodiment, the member 106 may select one vote to make webcam feed 304 private (e.g., based on the camera privacy preference). In another embodiment, the member 106 may select another vote to make the address (e.g., associated with the camera view) private (e.g., based on the address privacy preference).

In operation 716, the validity of the votes is determined (e.g., based on the residence of the member 106 at the location associated with the address). If the votes are not valid, then the process may terminate. If the votes are valid, then a validation level of the member 106 is determined (e.g., based on a confirmation of a residence of the member 106 at the location) in operation 718. For example, the validation level may be obtained from other members 106A-N of the community 104. In operation 720, access to the camera view and/or address are restricted based on the vote and the validation level. For example, the access may be restricted, if the location of the member 106 has been validated by a threshold number of members 106A-N of the community 104.

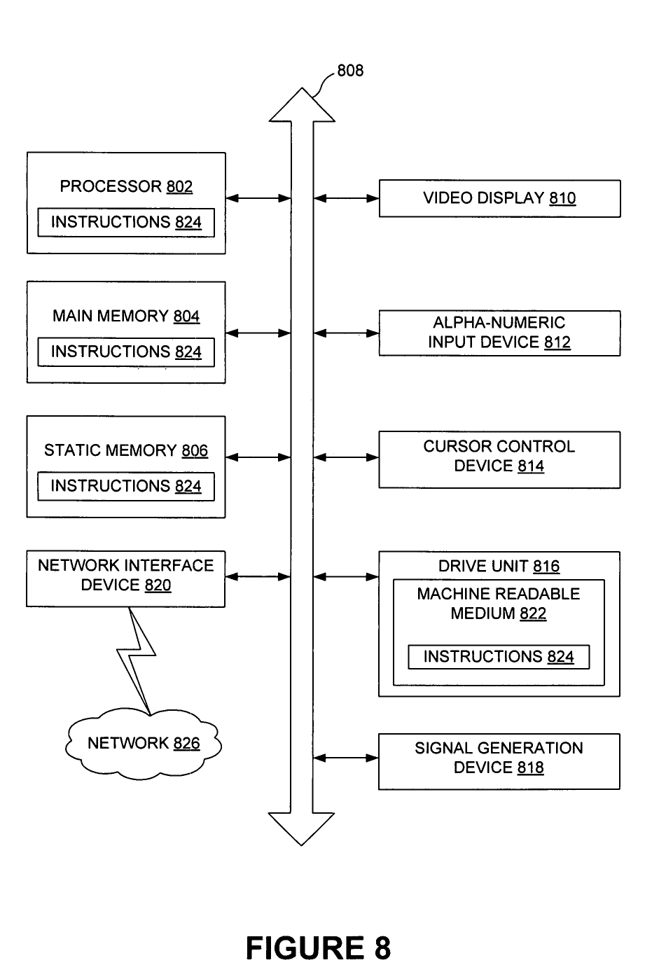

FIG. 8 is a diagrammatic system view 800 of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824 and a network 826, according to one embodiment.

The diagrammatic system view 800 may indicate a personal computer and/or a data processing system in which one or more operations disclosed herein are performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., special device to aid the physically handicapped). The cursor control device 814 may be a pointing device such as a mouse.

The drive unit 816 may be the hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from a network. The machine readable medium 822 may provide instructions on which any of the methods disclosed herein may be performed. The instructions 824 may provide source code and/or data code to the processor 802 to enable any one or more operations disclosed herein.

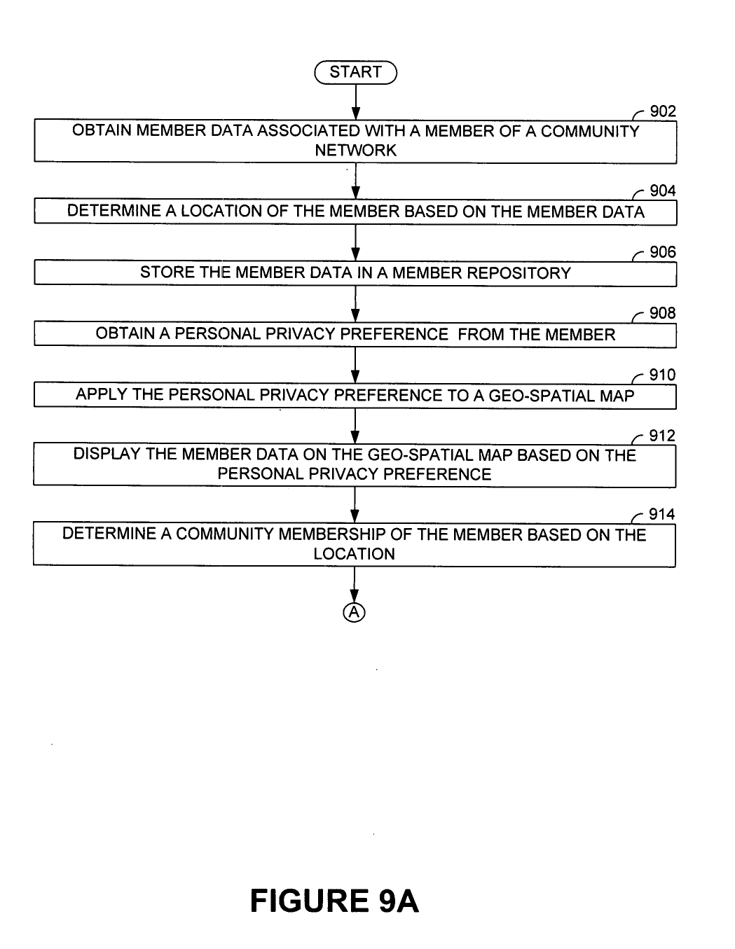

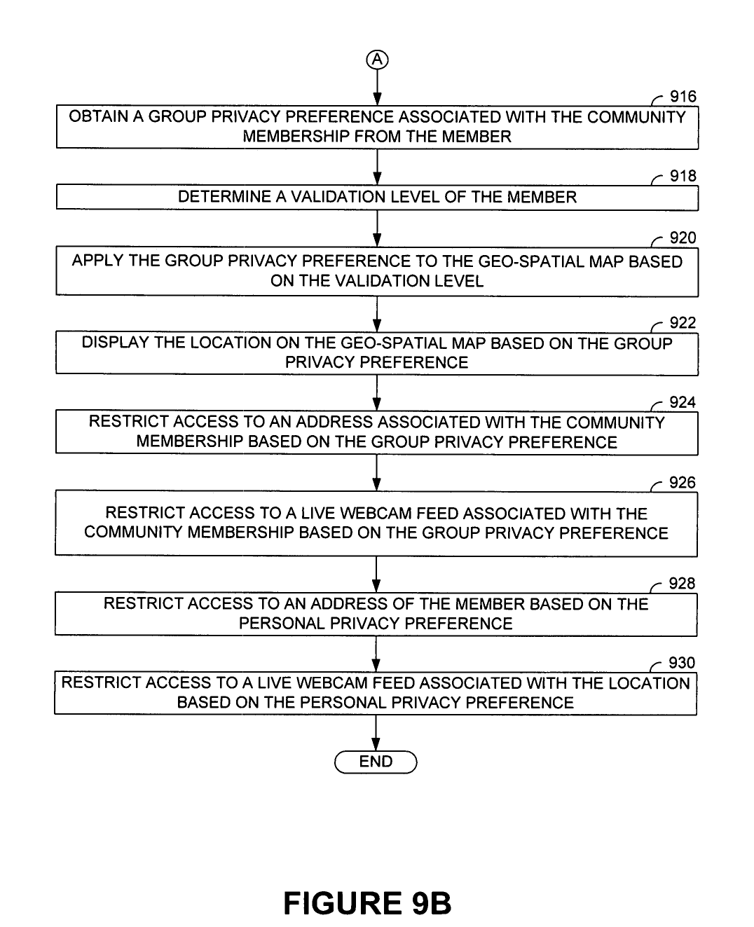

FIG. 9A is a process flow of organizing the community network 102, according to one embodiment. In operation 902, member data associated with a member (e.g., the members 106A-N of FIG. 1) of the community network 102 may be obtained (e.g., using the member management module 108 of FIG. 1). In operation 904, a location of the member 106 may be determined based on the member data. In operation 906, the member data may be stored in the member repository 114.

In operation 908, a personal privacy preference may be obtained (e.g., using the privacy module 110 of FIG. 1) from the member 106. In operation 910, the personal privacy preference may be applied to a geo-spatial map (e.g., the geo-spatial map 200 of FIG. 3). In operation 912, the member data may be displayed at the location on the geo-spatial map 200 based on the personal privacy preference. In operation 914, a community membership of the member 106 may be determined based on the location.

FIG. 9B is a continuation of the process flow of FIG. 9A illustrating additional processes, according to one embodiment. In operation 916, a group privacy preference associated with the community membership may be obtained (e.g., using the privacy module 110 of FIG. 1) from the member 106. In operation 918, a validation level of the member 106 may be determined (e.g., based on a confirmation of the community membership of the member 106). In operation 920, the group privacy preference may be applied to the geo-spatial map 200 based on the validation level. In operation 922, the location may be displayed on the geo-spatial map 200 based on the group privacy preference. In operation 924, access to an address (e.g., the address 302 of FIG. 4) associated with the community membership may be restricted (e.g., based on the group privacy preference).

In operation 926, access to a live webcam feed (e.g., the live webcam feed 304 of FIG. 4) associated with the community membership may be restricted (e.g., based on the group privacy preference). In operation 928, access to an address (e.g., the address 302 of FIG. 3) of the member 106 may be restricted (e.g., based on the personal privacy preference). In operation 930, access to a live webcam feed (e.g., the live webcam feed 304 of FIG. 3) associated with the location may be restricted (e.g., based on the personal privacy preference).

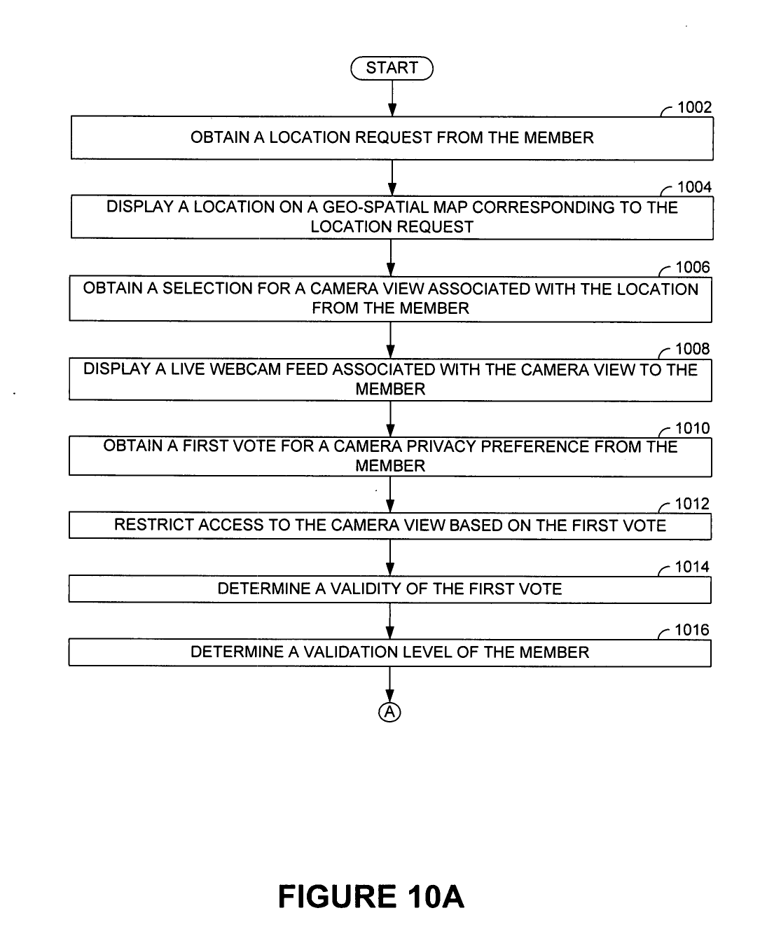

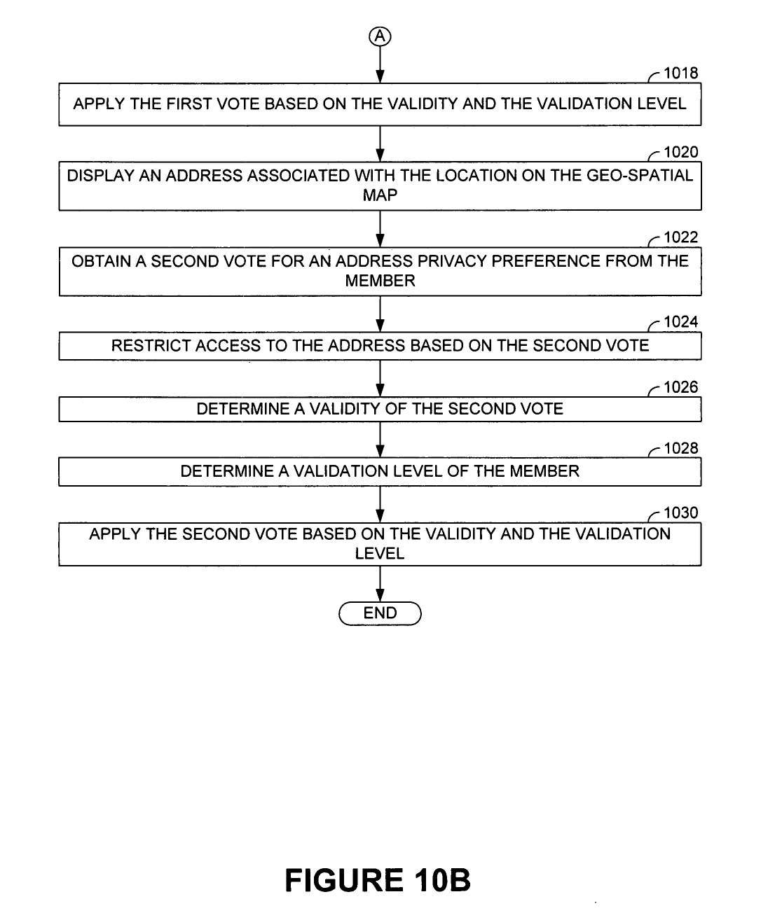

FIG. 10A is a process flow of restricting access to a camera view and/or an address associated with a location based on a first vote and second vote respectively, according to one embodiment. In operation 1002, a location request may be obtained from a member 106. For example, the location request may include searching a location based on name, latitude, longitude, clicking on a geo-spatial map, etc. In operation 1004, a location corresponding to the location request may be displayed on a geo-spatial map (e.g., the geo-spatial map 200 of FIGS. 2, 3, and 4). In operation 1006, a selection for a camera view associated with the location may be obtained (e.g., using the select a camera view option 206 of FIG. 2) from the member 106.

In operation 1008, a live webcam feed (e.g., the webcam feed 204 of FIG. 2) associated with the camera view (e.g., boardwalk view 208, ocean view 210 and/or land view 212 of FIG. 2) may be displayed to the member 106. In operation 1010, a first vote for a camera privacy preference may be obtained (e.g., using the vote to make this webcam feed private option 308 of FIG. 3) from the member 106. In operation 1012, access to the camera view may be restricted (e.g., using the privacy module 110 of FIG. 1) based on the first vote. In operation 1014, a validity of the first vote may be determined (e.g., may be based on a residence of the member 106 104A-N at the location). In operation 1016, a validation level of the member 106 may be determined (e.g., may be based on a confirmation of the residence of the member 106 at the location).

FIG. 10B is a continuation of the process flow of FIG. 10A illustrating additional processes, according to one embodiment. In operation 1018, the first vote may be applied (e.g., to the camera privacy preference) based on the validity and/or the validation level. In operation 1020, an address (e.g., the address 302 of FIG. 3) associated with the location may be displayed on the geo-spatial map 200.

In operation 1022, a second vote for an address privacy preference may be obtained (e.g., using the click here to make your address private option 310 of FIG. 3) from the member 106. In operation 1024, access to the address 302 may be restricted based on the second vote. In operation 1026, a validity of the second vote may be determined (e.g., as illustrated in FIG. 7). In operation 1028, a validation level of the member 106 may be determined. In operation 1030, the second vote may be applied to the address privacy preference based on the validity and/or the validation level.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 108, the privacy module 110 and other modules of FIGS. 1-14 may be enabled using a member management circuit, a privacy circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of organizing a community network, comprising:
obtaining member data associated with a member of the community network;
determining a location of the member based on the member data;
storing the member data in a member repository;
obtaining a personal privacy preference from the member;
applying the personal privacy preference to a geo-spatial map; and
displaying the member data at the location on the geo-spatial map based on the personal privacy preference.

2. The method of claim 1, further comprising:
determining a community membership of the member based on the location;
obtaining a group privacy preference associated with the community membership from the member;
determining a validation level of the member;
applying the group privacy preference to the geo-spatial map based on the validation level; and
displaying the location on the geo-spatial map based on the group privacy preference.

3. The method of claim 2, further comprising:
restricting access to an address associated with the community membership based on the group privacy preference.

4. The method of claim 2, further comprising:
restricting access to a live webcam feed associated with the community membership based on the group privacy preference.

5. The method of claim 2, wherein the validation level is based on a confirmation of the community membership of the member.

6. The method of claim 1, further comprising:
restricting access to an address of the member based on the personal privacy preference.

7. The method of claim 1, further comprising:
restricting access to a live webcam feed associated with the location based on the personal privacy preference.

8. A community network, comprising:
a member repository comprising a plurality of members;
a geo-spatial repository comprising a plurality of locations on a geo-spatial map;
a member management module configured to obtain member data associated with one of the plurality of members, wherein the member data comprises one of the plurality of locations; and
a privacy module configured to:
obtain a personal privacy preference from the one of the plurality of members;
apply the personal privacy preference to the geo-spatial map; and
display the member data at the one of the plurality of locations on the geo-spatial map based on the personal privacy preference.

9. The community network of claim 8, wherein the privacy module is further configured to:
determine a community membership of the one of the plurality of members based on the one of the plurality of locations;
obtain a group privacy preference associated with the community membership from the one of the plurality of members;
determine a validation level of the one of the plurality of members;
apply the group privacy preference to the geo-spatial map based on the validation level; and
display the one of the plurality of locations on the geo-spatial map based on the group privacy preference.

10. The community network of claim 9, wherein the privacy module is further configured to:
restrict access to an address associated with the community membership based on the group privacy preference.

11. The community network of claim 9, wherein the privacy module is further configured to:
restrict access to a live webcam feed associated with the community membership based on the group privacy preference.

12. The community network of claim 9, wherein the validation level is based on a confirmation of the community membership of the one of the plurality of members.

13. The community network of claim 8, wherein the privacy module is further configured to:
restrict access to an address of the one of the plurality of members based on the personal privacy preference.

14. The community network of claim 8, wherein the privacy module is further configured to:
restrict access to a live webcam feed associated with the one of the plurality of locations based on the personal privacy preference.

15. A method of configuring a community network for a member, comprising:
obtaining a location request from the member;
displaying a location on a geo-spatial map corresponding to the location request;
obtaining a selection for a camera view associated with the location from the member;
displaying a live webcam feed associated with the camera view to the member;
obtaining a first vote for a camera privacy preference from the member; and
restricting access to the camera view based on the first vote.

16. The method of claim 15, further comprising:
determining a validity of the first vote;
determining a validation level of the member; and
applying the first vote to the camera privacy preference based on the validity and the validation level.

17. The method of claim 16, wherein the validity is based on a residence of the member at the location.

18. The method of claim 16, wherein the validation level is based on a confirmation of a residence of the member at the location.

19. The method of claim 15, further comprising:
displaying an address associated with the location on the geo-spatial map;
obtaining a second vote for an address privacy preference from the member; and
restricting access to the address based on the second vote.

20. The method of claim 19, further comprising:
determining a validity of the second vote;
determining a validation level of the member; and
applying the second vote to the address privacy preference based on the validity and the validation level.
